(19) United States
(12) Patent Application Publication
(10) Pub. No.: US 2005/0176477 A1
(43) Pub. Date: Aug. 11, 2005

(54) Folding portable radio communication terminal

(76) Inventors: Kenichiro Kodama, Tokyo (JP); Tooru Fukasawa, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/517,365

(22) PCT Filed: Apr. 23, 2003
(86) PCT No.: PCT/JP03/05191

(51) Int. Cl. H04M 1/00

(52) U.S. Cl. 455/575.3; 455/575.7

(57) ABSTRACT

A problem to be solved by the invention is to improve antenna gain at the time of website browsing and to put the antenna gain at the time of a telephone call in an excellent state. The invention is a folding type portable radio communication terminal (10) including a first chassis (20) provided with a display part (22) at its front surface side, a second chassis (30) provided with an operation part (32) at its front surface side, a coupling part (40) for openably/closably coupling end parts (21, 31) of the first and the second chassis (20, 30) so that the front surface sides of the second chassis (30) and the first chassis (20) face each other, and a whip antenna (50) for data transmission/reception provided in the coupling part side end part (34) of the second chassis (30) to be capable of being pulled out, in which in a state where the first and the second chassis (20, 30) are opened, the whip antenna (50) is pulled out in a direction of approaching a back surface side of the first chassis (20) and is held.

### TECHNICAL FIELD

The present invention relates to a folding type portable radio communication terminal in which a first chassis having a display part and a second chassis having an operation part are rotatably connected to each other, and particularly to a folding type portable radio communication terminal in which antenna gain is improved.

### BACKGROUND ART

Conventionally, there has been a technique disclosed in JP-A-7-38461 (hereinafter referred to as “prior art document”).

This technique is constructed in such a way that a portable radio equipment includes a chassis, a reception part provided in the chassis, and an antenna, the chassis is divided into a first unit provided with at least the reception part, and a second unit rotatably connected to the first unit, and the antenna is pulled out vertically from a coupled side end surface of the second unit. At the time of usage, the antenna is pulled out in a state where the first and the second units are opened, so that it is extended in a direction away from the first unit, and a display part is attached to the first unit.

In the portable radio equipment disclosed in the prior art document, in a state where a user holds the reception part to the ear and makes a telephone call, since the antenna is pulled out in the direction away from the human body, there is a feature that the influence of the human body on the antenna gain can be reduced.

However, the portable radio equipment disclosed in the above prior art document has a problem that in a case where the user browses content on the Internet, the antenna gain is reduced.

This problem is specifically caused by following reasons.

That is, when browsing a website or performing mail communication by using the portable radio equipment divided into the first unit and the second unit, the user holds the second unit provided with the operation part substantially horizontally by hand, and performs the operation while seeing the display part of the first unit-opened to have a specific angle with respect to the second unit. Accordingly, since the second unit is held in the horizontal direction, the antenna vertically pulled out from the second unit is also naturally held in the horizontal direction.

In the portable radio equipment disclosed in the prior art document, in the case where a website is browsed, the antenna gain for a radio signal from a base station outputting vertically polarized radio signals is significantly degraded.

This invention solves the above problem and has following objects.

A first object of the invention is to provide a folding type portable radio communication terminal in which even in a case where a unit provided with an operation part is held horizontally and is used, antenna gain is not degraded.

A second object of the invention is to provide a folding type portable radio communication terminal in which at the time of a telephone call when a reception part of a unit provided with a display part is held to the ear and is used, antenna gain can be maintained in an excellent state.

### DISCLOSURE OF THE INVENTION

This invention is a folding type portable radio communication terminal including a first chassis provided with a display part at its front surface side, a second chassis provided with an operation part at its front surface side, a coupling part for openably/closably coupling end parts of the first and the second chassis so that the front surface sides of the second chassis and the first chassis face each other, and a whip antenna for data transmission/reception provided in the coupling part side end part of the second chassis to be capable of being pulled out, wherein in a state where the first and the second chassis are opened, the whip antenna is pulled out in a direction of approaching a back surface side of the first chassis and is held.

Accordingly, even in the case where the second chassis is disposed in the horizontal direction, since the whip antenna is pulled out at a specific angle with respect to the horizontal direction, it becomes easy for the whip antenna to receive the vertically polarized radio signal and the antenna gain is improved.

Further, since the electromagnetic wave radiated from the whip antenna is effectively reflected by the first chassis, it is possible to realize the folding type portable radio communication terminal in which the antenna gain at the time of a telephone call is made excellent.

### BRIEF DESCRIPTION OF THE DRAWINGS

FIG. 1 is a structural view showing a front surface side of a folding type cellular phone according to embodiment 1 of the invention.

FIG. 2 is a structural view showing a back surface side of the folding type cellular phone according to embodiment 1 of the invention.

FIG. 3 is a side view showing the folding type cellular phone according to embodiment 1 of the invention.

FIG. 4 is a sectional view showing the inside of the folding type cellular phone according to embodiment 1 of the invention.

FIG. 5 is a view showing an arrangement direction of the folding type cellular phone at the time of a telephone call.

FIG. 6 is a characteristic diagram showing results of simulation of gain characteristics of the folding type cellular phone.

FIG. 7 is a characteristic diagram showing results of simulation of gain characteristics of the folding type cellular phone.

FIG. 8 is a characteristic diagram showing results of simulation of gain characteristics of the folding type cellular phone.

FIG. 9 is a side view showing folding type cellular phones according to embodiments 2 to 5 of the invention.

FIG. 10 is a side view showing a folding type cellular phone according to embodiment 6 of the invention.

FIG. 11 is a side view showing a folding type cellular phone according to embodiment 7 of the invention.

FIG. 12 is a side view and a back view showing a folding type cellular phone according to embodiment 8 of the invention.

FIG. 13 is a side view and a back view showing a folding type cellular phone according to embodiment 9 of the invention.

FIG. 14 is a view showing a use state in which a telephone conversation is being made by the folding type cellular phone according to embodiment 9 of the invention.

### BEST MODE FOR CARRYING OUT THE INVENTION

### Embodiment 1

This embodiments is an embodiment applied to a folding type cellular phone as a folding type portable radio communication terminal.

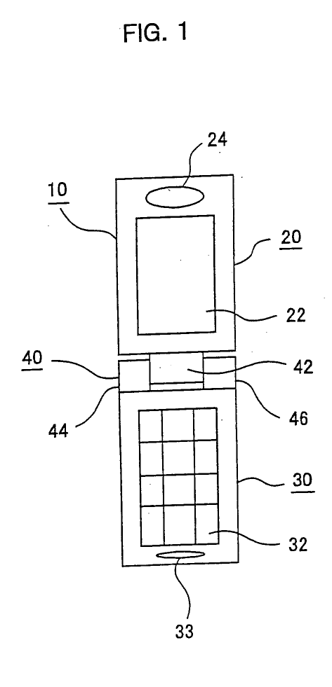

Hereinafter, the folding type cellular phone of embodiment 1 will be described with reference to FIGS. 1 to 4.

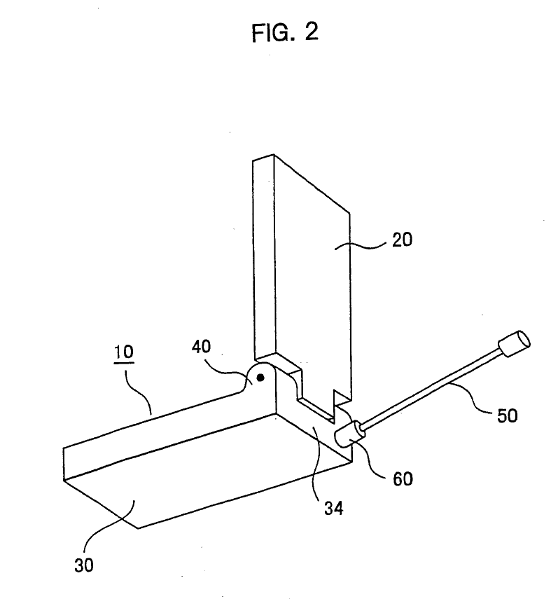

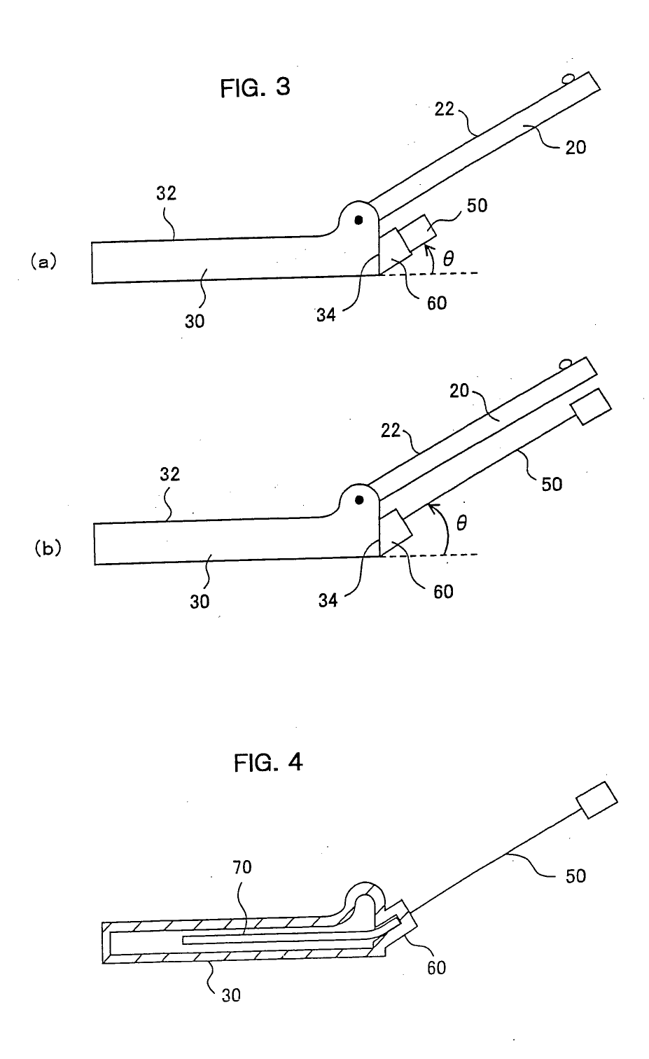

FIG. 1 is a structural view showing the folding type cellular phone which is in an open state and shown from its front surface side. FIG. 2 is a structural view showing a back surface side of the folding type cellular phone. FIG. 3(a) is a side view showing a state in which a whip antenna is contained in a chassis of the folding type cellular phone, and FIG. 3(b) is a side view showing a state where the whip antenna is pulled out from the chassis of the folding type cellular phone. Further, FIG. 4 is a sectional view showing the inner structure of the folding type cellular phone.

In the respective drawings, a folding type cellular phone 10 includes a coupling part 40 for openably/closably coupling an end of a first chassis 20 and an end of a second chassis 30 so that a front surface of the first chassis 20 and a front surface of the second chassis 30 face each other. The coupling part 40 is constructed in such a way that a coupling piece 42 provided at the first chassis 20 and coupling pieces 44 and 46 provided at the second chassis 30 so as to sandwich the coupling piece 42 therebetween are rotatably connected to each other. As shown in FIG. 1, a display part 22 made of an LCD (Liquid Crystal Display) and a receiver 24 for outputting a received audio signal are provided on the surface of the first chassis 20. On the other hand, an operation part 32 made of key switches, such as numeric keys, and a microphone 33 are provided on the surface of the second chassis 30.

Besides, a whip antenna 50 contained in the second chassis 30 to be capable of being pulled out is provided, and an outlet 60 for pulling out the whip antenna 50 from the second chassis 30 is provided at a coupling part side end surface (coupling part side end part) of the second chassis 30 to be inclined with respect to the coupling part side end surface 34.

In FIG. 3, the second chassis 30 of the folding type cellular phone 10 is disposed horizontally. In this case, the outlet 60 is formed so that the whip antenna 50 is pulled out in the direction of an angle θ with respect to the horizontal direction. Here, when the whip antenna 50 is pulled out in the state where the second chassis 30 is disposed in the horizontal direction, the angle θ between the horizontal direction and the pull-out direction of the whip antenna 50 will be referred to as the “pull-out angle” θ.

FIG. 4 shows the inner structure of the second chassis 30, and a containing case 70 for containing the whip antenna 50 is provided.

Next, the operation of the folding type cellular phone 10 in a case where the folding type cellular phone 10 is used for browsing a website will be described with reference to FIG. 3.

When the user operates the operation part 32 of the second chassis 30 while seeing the display part 22 of the first chassis 20 (hereinafter referred to as “website browsing time”), for example, when the user browses a website on the Internet by using the folding type cellular phone 10, the second chassis 30 is held in a state close to the horizontal (hereinafter, this hold state will be referred to as a “first hold state”). As shown in FIG. 3(b), the whip antenna 50 is pulled out in the direction approaching the back surface side of the first chassis 20 in the state where the first chassis 20 and the second chassis 30 are opened and is held. Thus, the pull-out angle θ of the folding type cellular phone 10 does not become 0°. Accordingly, with respect to the reception of a vertically polarized radio signal, the antenna gain of the folding type cellular phone 10 is improved as compared with the portable radio equipment disclosed in the prior art document.

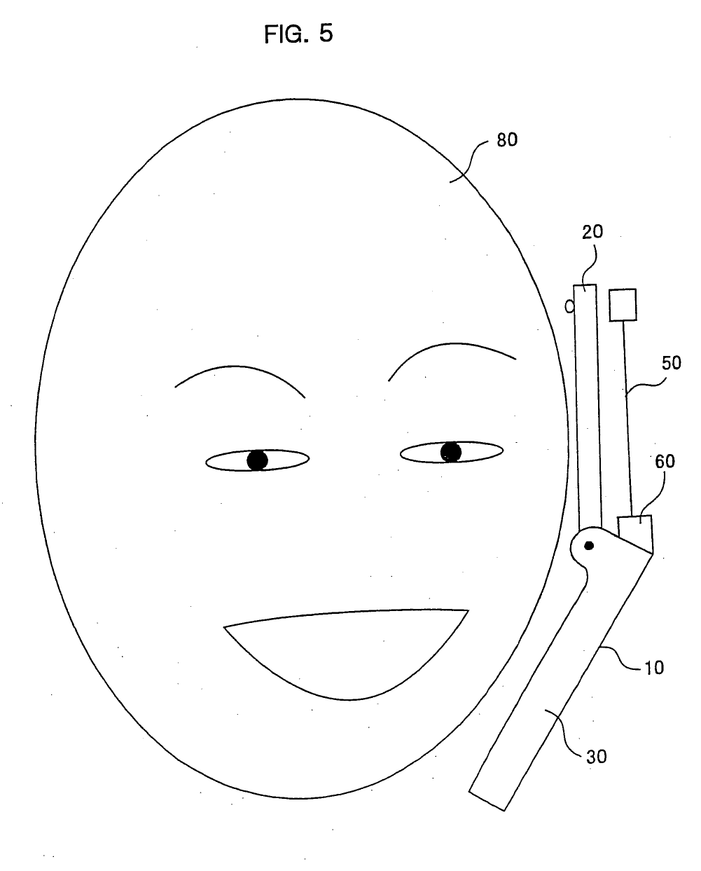

Next, the operation of the folding type cellular phone 10 in the case where the folding type cellular phone 10 is used for a telephone call will be described with reference to FIG. 5.

In the case where the folding type cellular phone 10 is used for the telephone call, since the receiver 24 provided at the end part of the first chassis 20 is held to the user's ear and is used, the first chassis 20 is made to approach the periphery of the ear of a human head 80 and is used (hereinafter, this use state will be referred to as a “second hold state”) Accordingly, in the case where the folding type cellular phone 10 is used for the telephone call, the human head 80 as an obstacle to the transmission/reception of a radio signal is positioned in the vicinity of the whip antenna 50. However, as shown in FIG. 5, in the folding type cellular phone 10 of this embodiment, the whip antenna 50 is constructed so as to approach the first chassis 20. Thus, since the electromagnetic wave radiated from the whip antenna 50 is effectively reflected by the first chassis 20, it has an advantageous influence on the antenna gain at the time of the telephone call in the second hold state. That is, in the folding type cellular phone 10, even at the time of the telephone call, the antenna gain is hardly degraded by the human head 80.

Hereinafter, in the folding type cellular phone 10 according to embodiment 1, simulation results will be described which indicate that the antenna gain at the time of website browsing is improved and the antenna gain at the time of a telephone call is in an excellent state.

This confirmation was performed by simulation using an FDTD method (Finite Difference Time Domain Method).

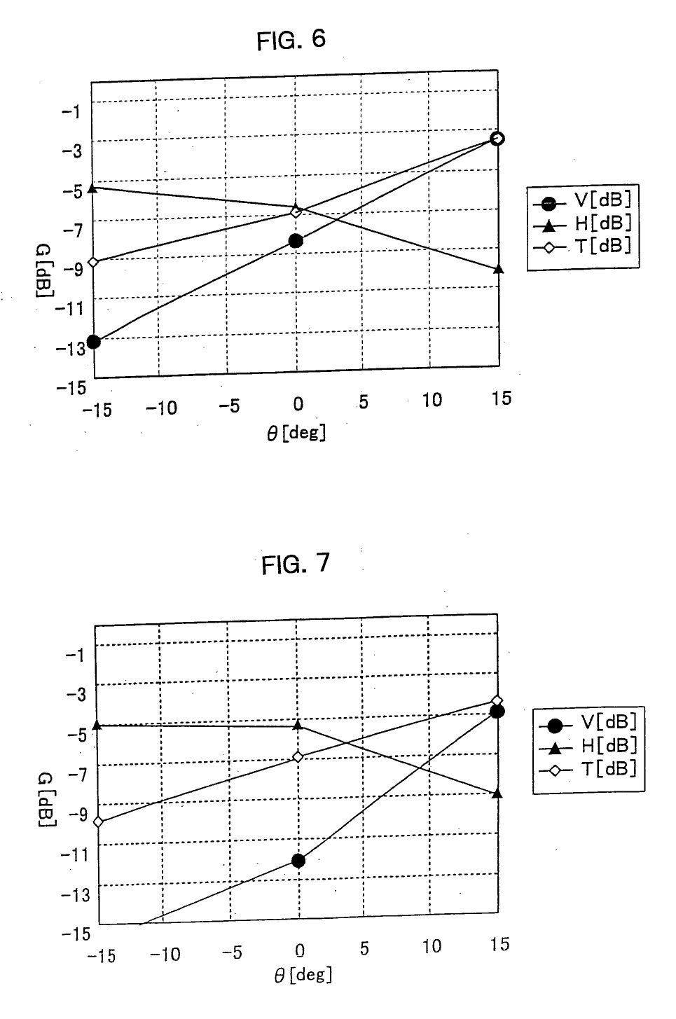

FIGS. 6 and 7 show simulation results in which the antenna gain of the folding type cellular phone 10 at the time of website browsing (first hold state) is calculated.

FIG. 6 shows, when the pull-out angle θ is an angle between −15° to +15° and in a case (first condition) where the second chassis 30 is held at an inclined angle φ of 30° with respect to the horizontal direction, antenna gain V [dB] of the folding type cellular phone 10 for a vertically polarized radio signal, antenna gain H [dB] for a horizontally polarized radio signal, and antenna gain T [dB] for a radio signal in which a vertically polarized radio signal from a base station outputting vertically polarized radio signals and a horizontally polarized radio signal are mixed.

According to the simulation results of FIG. 6, as the pull-out angle θ is increased, the antenna gain V [dB] for the vertically polarized radio signal is increased. On the other hand, as the pull-out angle θ is increased, the antenna gain H [dB] for the horizontally polarized radio signal is decreased. However, the antenna gain T [dB] for the whole radio signal in which the vertically polarized wave and the horizontally polarized wave are mixed is increased.

FIG. 7 shows, when the pull-out angle θ is an angle between −15° to +15° and in a case (second condition) where the second chassis is held at an inclined angle θ of 15° with respect to the horizontal direction, antenna gain V [dB] of the folding type cellular phone 10 for a vertically polarized radio signal, antenna gain H [dB] for a horizontally polarized radio signal, and antenna gain T [dB] for a radio signal in which a vertically polarized radio signal from a base station outputting vertically polarized radio signals and a horizontally polarized radio signal are mixed.

According to the simulation results of FIG. 7, as the pull-out angle θ is increased, the antenna gain V [dB] is increased. On the other hand, as the pull-out angle θ is increased, the antenna gain H [dN] is decreased. However, the whole antenna gain T [dB] is increased.

Accordingly, as the whip antenna 50 is disposed so as to approach the first chassis 20, the antenna gain of the folding type cellular phone 10 at the time of website browsing is improved.

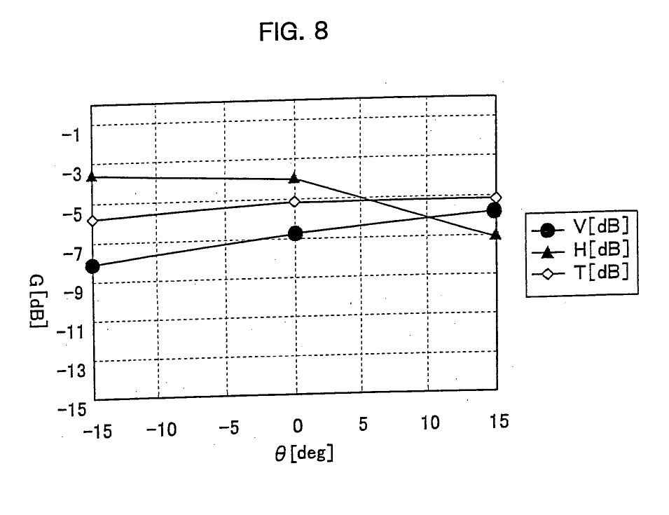

FIG. 8 shows simulation results in which antenna gain of the folding type cellular phone 10 at the time of a telephone call (second hold state) is calculated.

FIG. 8 shows, at the time of a telephone call and in a case where the pull-out angle θ is an angle between −15° to +15°, antenna gain V [dB] of the folding type cellular phone 10 for a vertically polarized radio signal, antenna gain H [dB] for a horizontally polarized radio signal, and antenna gain T [dB] for a radio signal in which a vertically polarized radio signal from a base station outputting vertically polarized radio signals and a horizontally polarized radio signal are mixed.

According to the simulation results of FIG. 8, as the pull-out angle θ is increased, the antenna gain V [dB] is increased. On the other hand, as the pull-out angle θ is increased, the antenna gain H [dB] is decreased. However, the whole antenna gain T [dB] is hardly changed.

Accordingly, even if the whip antenna 50 is disposed so as to approach the first chassis 20, the antenna gain of the folding type cellular phone 10 at the time of a telephone call is not degraded.

The effects of embodiment 1 will be described.

According to embodiment 1 of this invention, even in the case where the second chassis 30 is held in the horizontal direction, since the whip antenna 50 is pulled out at an angle with respect to the horizontal direction, the vertically polarized radio signal becomes easy to receive. Thus, the antenna gain at the time of website browsing or the time of mail transmission can be improved.

Further, since the electromagnetic wave radiated from the whip antenna is effectively reflected by the first chassis, the antenna gain is not degraded at the time of a telephone call as well.

### Embodiment 2

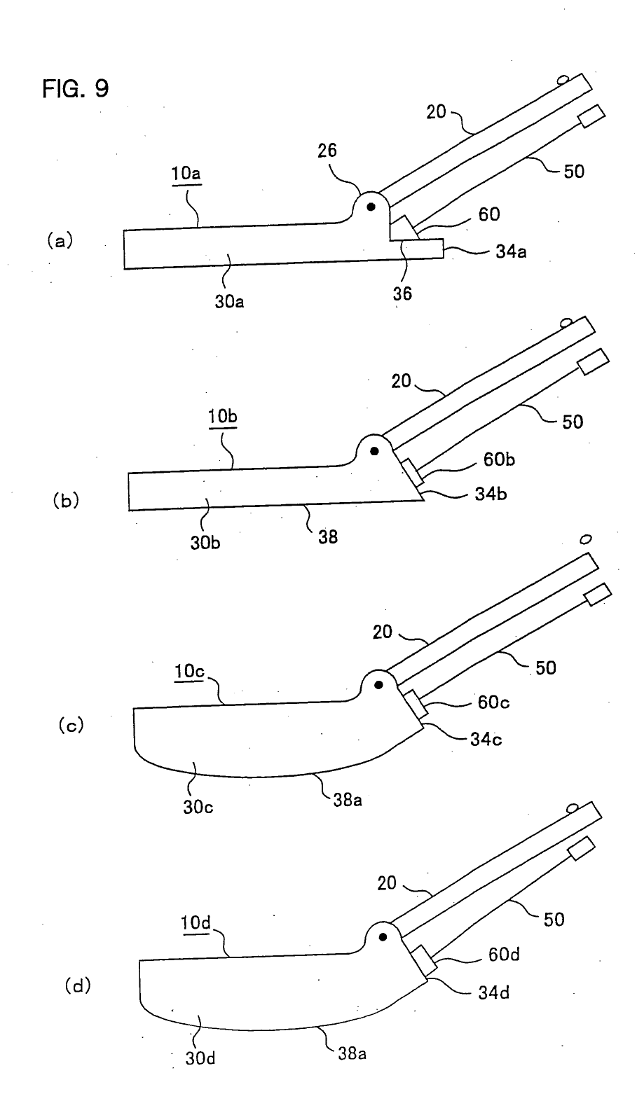

A folding type cellular phone of embodiment 2 will be described with reference to FIG. 9(a). FIG. 9(a) is a side view of the folding type cellular phone according to embodiment 2.

A folding type cellular phone 10a of embodiment 2 is an example of a folding type portable radio communication terminal in which in a state where a first and a second chassis are opened, a whip antenna 50 is pulled out in a direction of approaching a back surface side of the first chassis and is held. Specifically, in a state where a first chassis 20 and a second chassis 30a are closed, a coupling part side end surface 34a of the second chassis 30a is constructed to protrude more than a coupling side end surface 26 of the first chassis 20, and the whip antenna 50 is provided to be capable of being pulled out from a protrusion part (protruding portion) 36 of the second chassis 30a.

Also in the folding type cellular phone 10a having the above structure, since the pull-out angle θ does not become 0°, similar effects to embodiment 1 can be obtained.

Further, by using the protrusion part 36, a space used for the attachment of the whip antenna 50 can be made large, and the whip antenna 50 can be attached to various positions.

### Embodiment 3

A folding type cellular phone of embodiment 3 will be described with reference to FIG. 9(b). FIG. 9(b) is a side view of the folding type cellular phone according to embodiment 3.

A folding type cellular phone 10b of embodiment 3 is an example of a folding type portable radio communication terminal in which in a state where a first and a second chassis are opened, a whip antenna 50 is pulled out in a direction of approaching a back surface side of the first chassis and is held. Specifically, a coupling part side end surface 34b is provided obliquely to a bottom 38 of a second chassis 30b, and an outlet 60b is attached vertically to the coupling part side end surface 34b.

Also in the folding type cellular phone 10b having the above structure, since the pull-out angle θ does not become 0°, similar effects to embodiment 1 can be obtained.

### Embodiment 4

A folding type cellular phone of embodiment 4 will be described with reference to FIG. 9(c). FIG. 9(c) is a side view of a folding type cellular phone 10c according to embodiment 4.

The folding type cellular phone 10c of embodiment 4 is an example of a folding type portable radio communication terminal in which in a state where a first and a second chassis are opened, a whip antenna 50 is pulled out in a direction of approaching a back surface side of the first chassis and is held. Specifically, an outlet 60c is attached vertically to a coupling part side end surface 34c. The coupling part side end surface 34c is not provided obliquely to a bottom 38a of a second chassis 30c. However, in the case where the second chassis 30c is disposed in the horizontal direction, since the coupling part side end surface 34c is provided obliquely to the horizontal direction, the pull-out angle θ does not become 0°. Accordingly, similar effects to embodiment 1 can be obtained.

### Embodiment 5

A folding type cellular phone of embodiment 5 will be described with reference to FIG. 9D. FIG. 9D is a side view of a folding type cellular phone 10d according to embodiment 5.

The folding type cellular phone 10d of embodiment 5 is an example of a folding type portable radio communication terminal in which in a state where a first and a second chassis are opened, a whip antenna 50 is pulled out in a direction of approaching a back surface side of the first chassis and is held. In the folding type cellular phone of embodiments 1 to 4, in the case where the first and the second chassis are put into the open state, the whip antenna 50 is pulled out so that the first chassis 20 and the whip antenna 50 become parallel to each other. However, in the folding type cellular phone 10d of this embodiment 5, the whip antenna 50 is not parallel to the first chassis 20, but is pulled out in a direction of further approaching the back surface side of the first chassis 20. The other structure is the same as the other embodiments.

Also in the folding type cellular phone 10d having the above structure, since the pull-out angle θ does not become 0°, similar effects to embodiment 1 can be obtained.

### Embodiment 6

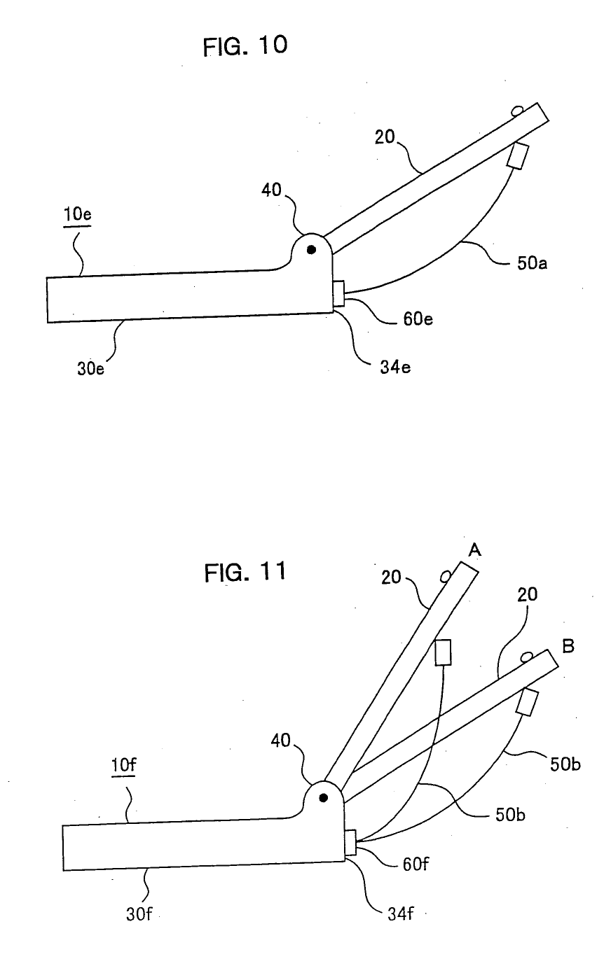

A structure of a folding type cellular phone of embodiment 6 will be described with reference to FIG. 10. In a folding type cellular phone 10e of embodiment 6, a whip antenna 50a is formed into a curved shape in advance so that the whip antenna approaches the back surface side of a first chassis 20 in a state where it is pulled out.

According to the folding type cellular phone 10e having the structure as stated above, even when an outlet 60e is provided vertically to an end surface 34e of a second chassis 30e, the whip antenna 50a can be pulled out from the second chassis 30e so as to have a component of the vertical direction. Thus, similar effects to the first embodiment can be obtained.

### Embodiment 7

A folding type cellular phone of embodiment 7 will be described with reference to FIG. 11.

In a folding type cellular phone 10f of embodiment 7, a whip antenna 50b is formed into a curved shape having a large curvature, and in a state where a first chassis 20 and a second chassis 30f are closed, the whip antenna 50b is disposed at position A in the drawing. Thus, in the middle of a movement of the first chassis 20 from position A to position B by an open operation to the first chassis 20, the whip antenna 50b comes in contact with the back surface of the first chassis 20. By further performing the open operation, the tip of the whip antenna 50b slides on the back surface of the first chassis 20, and the whip antenna 50b is extended. As a result, the whip antenna 50b is disposed at position B. When the first chassis 20 is moved from position B to position A, the whip antenna 50b is moved from position B to position A by restoring force. The other structure is the same as the other embodiments.

In the folding type portable radio communication terminal (folding type cellular phone) of embodiment 7, the tip of the whip antenna 50b comes in contact with the back surface of the first chassis in the middle of the open operation of the first and the second chassis (20, 30f), and by further performing the open operation, the tip of the whip antenna 50b slides on the back surface of the first chassis, and the whip antenna 50b is extended.

Accordingly, it is possible to obtain the folding type portable radio communication terminal (folding type cellular phone) 10f in which in the case where the second chassis 30f is held in the horizontal direction, the whip antenna 50b can be disposed at the position where the optimum antenna gain can be obtained.

### Embodiment 8

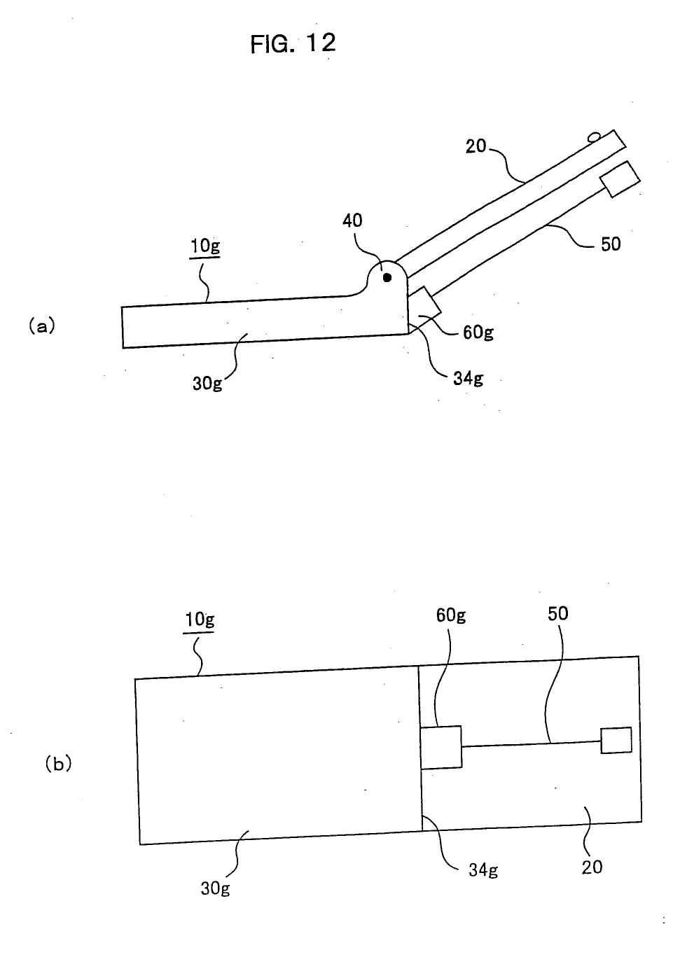

A folding type cellular phone of embodiment 8 will be described with reference to FIGS. 12(a) and 12(b). FIG. 12(a) is a side view of the folding type cellular phone according to embodiment 8, and FIG. 12(b) is a back view of the folding type cellular phone according to embodiment 8. A folding type cellular phone 10g of embodiment 8 is characterized in that a whip antenna 50 is constructed to be positioned substantially at the center of a coupling part side end surface 34g of a second chassis 30g. The other structure is the same as the other embodiments.

According to the structure as stated above, it is possible to prevent the electromagnetic wave radiated from the whip antenna 50 from being refracted by the surface of the first chassis 20, and the first chassis 20 effectively reflects the electromagnetic wave. Accordingly, the antenna gain can be further improved.

### Embodiment 9

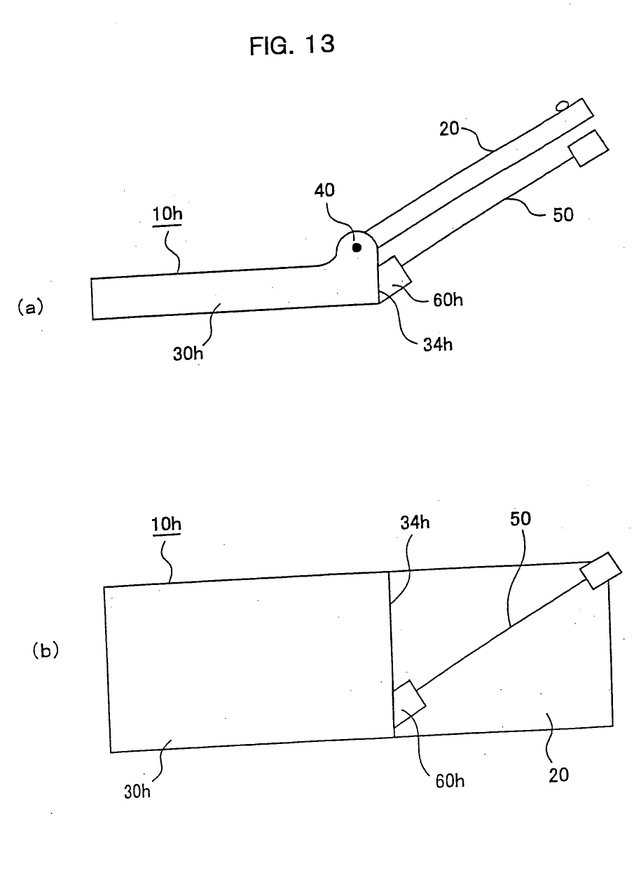

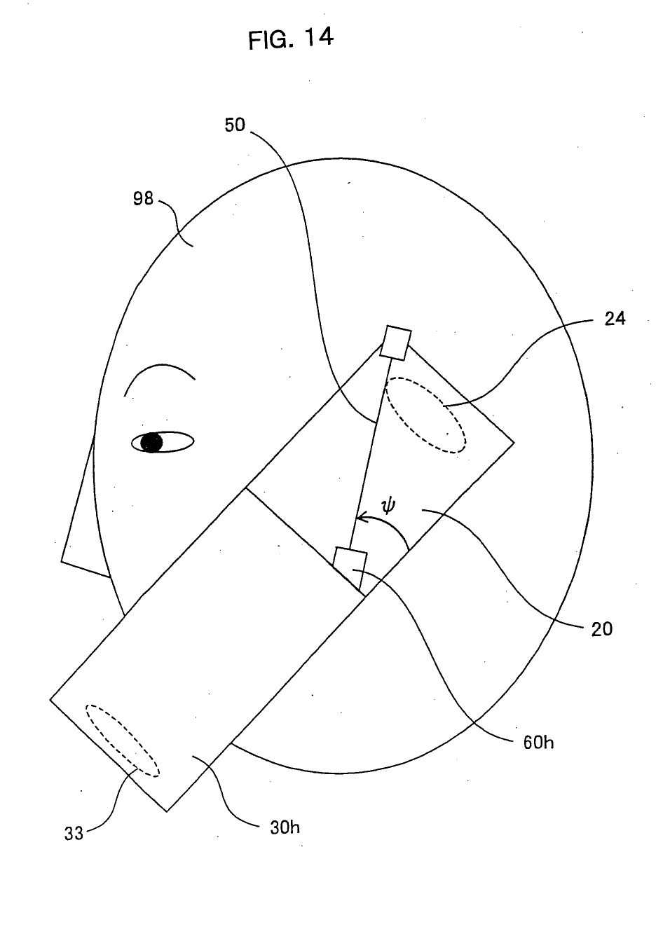

A folding type cellular phone of embodiment 9 will be described with reference to FIGS. 13(a) and 13(b). FIG. 13(a) is a side view of the folding type cellular phone according to embodiment 9, and FIG. 13(b) is a back view of the folding type cellular phone according to embodiment 9. A folding type cellular phone 10h of embodiment 9 is characterized in that a whip antenna 50 is pulled out and is held in a direction inclined by a specified angle ψ from the vertical direction with respect to a second chassis end surface 34h. The other structure is the same as the other embodiments.

In the case where the folding type cellular phone 10h is used for a telephone call, as shown in FIG. 14, a receiver 24 provided in a first chassis 20 is disposed in the vicinity of the ear of a user 98, and a microphone 33 provided in a second chassis 30h is disposed in the vicinity of a mouth of the user 98. In such a case, the folding type cellular phone 10h is generally used to be inclined by 60° from the horizontal direction.

Accordingly, according to the folding type portable radio communication terminal (folding type cellular phone) 10h as described above, in the case where the folding type cellular phone 10h is used for a telephone call, the direction of the whip antenna 50 approaches the vertical direction. Thus, the antenna gain at the time of the telephone call is further improved.

1. A folding type portable radio communication terminal comprising:
a first chassis provided with a display part at its front surface side;
a second chassis provided with an operation part at its front surface side;
a coupling part for openably/closably coupling end parts of the first and the second chassis so that the front surface sides of the second chassis and the first chassis face each other; and
a whip antenna for data transmission/reception provided in the coupling part side end part of the second chassis to be capable of being pulled out,
characterized in that in a state where the first and the second chassis are opened, the whip antenna is pulled out in a direction of approaching a back surface side of the first chassis and is held.

2. A folding type portable radio communication terminal according to claim 1, characterized in that
the whip antenna is formed into a curved shape in advance, so that the whip antenna approaches the back surface side of the first chassis in a pulled-out state.

3. A folding type portable radio communication terminal according to claim 2, characterized in that
a tip of the whip antenna comes in contact with the back surface of the first chassis in the middle of an open operation of the first and the second chassis, and when the open operation is further performed, the whip antenna is extended while the tip slides on the back surface of the first chassis.

4. A folding type portable radio communication terminal according to claim 1, characterized in that
the folding type portable radio communication terminal is constructed in such a way that in a state where the first chassis and the second chassis are closed, the coupling part side end part of the second chassis protrudes more than the coupling part side end part of the first chassis, and
the whip antenna is provided to be capable of being pulled out from a protruding portion of the second chassis.

5. A folding type portable radio communication terminal according to claim 1, characterized in that
the whip antenna is constructed to be positioned substantially at a center of the coupling part side end part of the second chassis.

6. A folding type portable radio communication terminal according to claim 1, characterized in that
the whip antenna is pulled out in a direction inclined by a specified angle from a vertical direction with respect to an end surface of the second chassis and is held.
